(19) United States
(12) Patent Application Publication
(10) Pub. No.: US 2009/0219207 A1
(43) Pub. Date: Sep. 3, 2009

(54) SIGNAL RECEIVING SYSTEM

(75) Inventors: Eiji Shibuya, Kobe-shi (JP); Takayuki Yoshii, Kobe-shi (JP)

Correspondence Address: DUANE MORRIS LLP - Philadelphia;IP DEPARTMENT, 30 SOUTH 17TH STREET, PHILADELPHIA, PA, 19103-4196, US

(73) Assignee: DX Antenna Company, Limited, Kobe-shi (JP)

(21) Appl. No.: 12/364,151

(22) Filed: Feb. 2, 2009

(30) Foreign Application Priority Data
Feb. 29, 2008 (JP) 2008-50056

(51) Int. Cl. H04B 7/00

(52) U.S. Cl. 342/367

(57) ABSTRACT

A variable directivity antenna (2) has directivity direction variable stepwise along the circumference of a circle centered about it. A tuner (8) selects a desired one from high frequency signals received at the antenna (2). The tuner (8) detects the level of the received signal and supplies it to a control unit (10). The control unit (10) searches for reception signal levels, equal to or higher than a threshold level, of the received signal received in antenna states in which the directivity of the antenna (2) is placed in different ones of directivity directions, and detects a signal-to-noise ratio of the signal received from directions adjacent to each of the searched directivity directions corresponding to the searched signal levels. The control unit (10) employs the searched directivity direction for the highest signal-to-noise ratio as the direction to which the antenna (2) is directed to receive the signal.

This invention relates to a signal receiving system and, more particularly, to a signal receiving system used with a variable directivity antenna.

### BACKGROUND OF THE INVENTION

An example of signal receiving systems used with a variable directivity antenna is disclosed in U.S. Pat. No. 7,277,063 B2 which issued on Oct. 2, 2007. According to the technique disclosed in this publication, the direction in which a variable directivity antenna exhibits its directivity can be successively changed in the circumferential direction at predetermined angular intervals.

In order to receive a desired signal wave with such variable directivity antenna, the direction of the antenna directivity is successively changed, and the level of the desired signal wave received in the respective directions is detected. The direction of directivity in which the received signal level is at or above a given threshold may be adopted as the orientation of the antenna. If, however, the variable directivity antenna is under multipath influence, the received signal level may be equal to or above the given threshold although the antenna directivity is not in the true direction in which the desired signal wave comes to the antenna, so that an improper direction is adopted as the orientation of the antenna. For example, when a wave of a particular terrestrial digital broadcast channel is received by an antenna with its directivity set in a wrong direction, block noise may appear in a displayed picture or, sometimes, a picture may black out due to degradation of a signal-to-noise ratio (S/N) and/or a bit error rate (BER). If the orientation of a variable directivity antenna is set improperly when installing the antenna first time, terrestrial digital broadcast waves cannot be received so that pictures with block noise will displayed always and/or the pictures may be blacked out.

An object of the present invention is to provide a signal receiving system which can prevent the directivity direction of a variable directivity antenna from being set to an improper direction.

### SUMMARY OF THE INVENTION

According to an aspect of the present invention, a signal receiving system includes a variable directivity antenna. The variable directivity antenna has a directivity direction variable stepwise along a circumference of a circle centered about the antenna. The direction of directivity may be changed by, for example, mechanically changing the orientation of the antenna. Alternatively, the variableness of antenna directivity may be obtained by, for example, forming an antenna with a plurality of antenna elements, e.g. dipole antenna elements, mechanically arranging the antenna elements to exhibit different directivity directions, for example, transversely disposing them, and adjusting the levels of signals received at the respective antenna elements by level adjusting means or electrically altering the phases of the received signals, before combining them, to thereby electrically vary the directivity direction without need for changing the orientation of the antenna. Signal receiving means selectively receives a desired one of high-frequency signals received by the variable directivity antenna. The signal receiving means may include tuning means for selecting a signal wave at a desired frequency. The tuning means may be arranged to be selectively tunable to different frequencies. The level of the signal received by the signal receiving means is detected by level detecting means. The level detecting means may be arranged to detect the level of a high frequency signal as selected by the signal receiving means. Alternatively, when the system is arranged such that the high frequency signal received by the signal receiving means is frequency-converted into an intermediate frequency signal before demodulation, the level detecting means may detect the level of the intermediate frequency signal or detect the demodulated signal. Searching means searches the received signals developed in a plurality of states in which the variable directivity antenna is placed in different directivity directions, for a signal having a level equal to or higher than a predetermined threshold. Comparing means may be used as the searching means, which compares the level of the received signals with the predetermined threshold. Different received signals are successively supplied to the searching means. Detecting means detects the ratio of the searched received signal to noise (S/N), the ratio of the carrier of the received signal to noise (C/N), or the bit error rate (BER) of the searched received signal, in the directivity direction adjacent to the searched directivity direction, which is the directivity direction corresponding to the searched received signal. Judging means judges that the searched directivity direction corresponding to the largest S/N or C/N or the smallest BER should be the direction for the variable directivity antenna to receive the signal.

Let it be assumed that, because of multi-path influence, for example, the directivity of the antenna is placed in a direction different from the correct one, from which the desired wave comes. In such case, the signal-to-noise (S/N) ratio measured in a directivity direction adjacent to the current, incorrect direction is low because the desired wave is not present in and around that direction. On the other hand, when the directivity direction of the antenna is along the direction from which the desired signal wave is coming, the S/N ratio measured in the directivity direction adjacent to the current, correct direction is higher for certain than in the above-described case because there is the desired signal wave coming from the direction near it. Accordingly, if there are a plurality of received signal levels equal to or higher than a threshold level, it is possible to prevent the directivity direction of the variable directivity antenna from being set to a wrong direction, by using the detecting means to measure the signal-to-noise ratio in the directions adjacent to the directivity directions for the plurality of signal levels equal to or higher than the threshold and adopting, as the orientation of the variable directivity antenna, the searched directivity direction of the highest S/N ratio. The same effect can be obtained by using the carrier-to-noise (C/N) ratio, or the bit error rate when the received signal is a carrier modulated with a digital signal.

The detecting means may be arranged to detect the S/N ratio, the C/N ratio or the bit error rate in the directions adjacent on both sides of the searched directivity direction. The two S/N or C/N ratios or the two BER rates detected in the adjacent two directions may be averaged, or either a higher one or lower one of the two ratios may be selected. The averaged or selected ratios or bit error rates for different directions are compared in the judging means to determine the highest ratio or the lowest BER rate, and the searched directivity direction is employed as the antenna directivity direction.

By measuring the S/N or C/N ratios or BER's in the directions on opposite sides of the searched directivity direction, as described above, it is possible to prevent, with a higher precision, the antenna directivity from being set to a wrong direction.

The detecting means, when there are more than or equal to a predetermined number of received signal levels equal to or higher than the threshold level, may be arranged to detect the S/N or C/N ratios or the BER's in the directivity directions adjacent to the directivity directions of a prescribed number of received signal levels selected in the order of the magnitude of the received signal levels higher or equal to the threshold level, the highest one first. When there are many signals received with levels higher than the threshold level, a long time is required for measuring the S/N or C/N ratios or BER's for all of such signals. Generally, when the received signal level is higher, the stronger is the possibility of the searched directivity direction being the correct direction from which the desired signal wave comes. Then, if there are more than a predetermined number of the received signals equal to or above the threshold, the S/N or C/N ratios or BER's of a prescribed number of signals selected in the order of the magnitude, the largest first, are measured, so that the time required for determining the orientation of the variable directivity antenna can be short.

The signal receiving means or the variable directivity antenna may be provided with amplifying means. The amplifying means operates to amplify the high frequency signals received by the variable directivity antenna or the received signal at the signal receiving means when no signals have a level equal to or higher than the threshold level, or operates when the number of signals having a level equal to or higher than the threshold level is smaller than the predetermined number. The amplified high frequency signal is applied to the signal receiving means, or the amplified received signal is applied to the level detecting means and to the detecting means. The level detecting means, the detecting means and the judging means operate in the manner as described previously.

With the described arrangement, if the high frequency signal has a low level, for example, the high frequency signal itself or the signal at the signal receiving means is amplified to have a level equal to or higher than the threshold level, which increases the feasibility of preventing the directivity direction of the variable directivity antenna from being set to a wrong direction.

### BRIEF DESCRIPTION OF THE DRAWINGS

FIG. 1 is a block diagram of a signal receiving system according to a first embodiment of the present invention.

FIG. 2 is a block diagram of a variable directivity antenna used in the signal receiving system of FIG. 1.

FIG. 3 shows how the directivity of the variable directivity antenna changes in the signal receiving system of FIG. 1.

FIG. 4a shows received signal levels in a given searched directivity direction b and adjacent directivity directions a and c in the signal receiving system of FIG. 1; FIG. 4b shows received signal levels in a given searched directivity direction g and adjacent directivity directions f and h; and FIG. 4c shows received signal levels in a given searched directivity direction l and adjacent directivity directions k and m.

FIG. 5 is a flow chart of a first part of the direction setting processing to be executed in the signal receiving system of FIG. 1.

FIG. 6 is a flow chart of a second part of the direction setting processing to be executed in the signal receiving system of FIG. 1.

FIG. 7 is a flow chart of a third part of the direction setting processing to be executed in the signal receiving system of FIG. 1.

FIG. 8 is a flow chart of a fourth part of the direction setting processing to be executed in the signal receiving system of FIG. 1.

FIG. 9 is a flow chart of a fifth part of the direction setting processing to be executed in the signal receiving system of FIG. 1.

FIG. 10 is a first modification of the second part shown in FIG. 6.

FIG. 11 is a first modification of the third part shown in FIG. 7.

FIG. 12 is a first modification of the fourth part shown in FIG. 8.

FIG. 13 is a second modification of the second part shown in FIG. 6.

FIG. 14 is a second modification of the third part shown in FIG. 7.

FIG. 15 is a second modification of the fourth part shown in FIG. 8.

### AN EMBODIMENT OF THE INVENTION

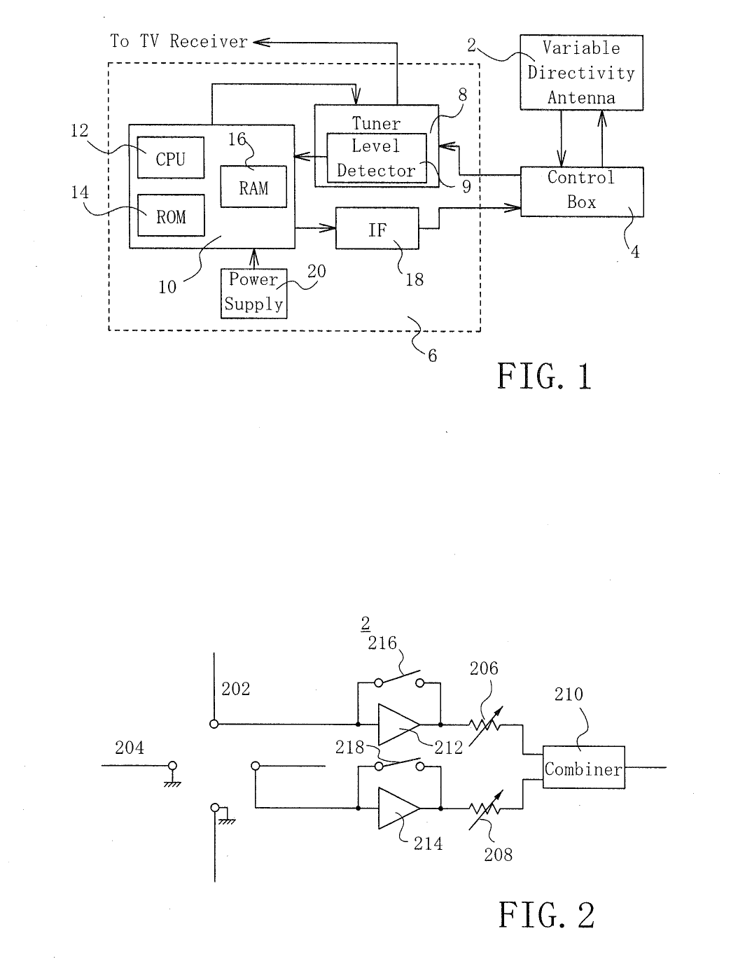

A signal receiving system according to one embodiment of the invention is a signal receiving system for receiving UHF-band terrestrial digital broadcast signals. The signal receiving system includes a variable directivity antenna 2 as shown in FIG. 1.

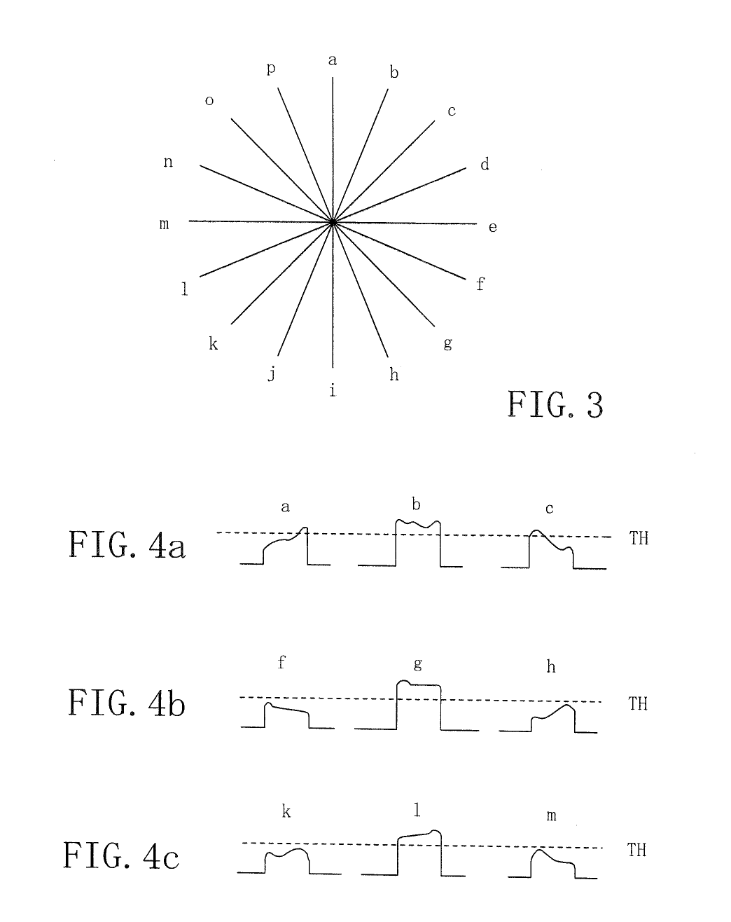

The variable directivity antenna 2 may be an antenna disclosed in, for example, WO 2004/091043, which includes a plurality, e.g. two of antenna elements, for example, dipole antennas 202 and 204 disposed to cross orthogonally with each other, as shown in FIG. 2. A high frequency signal received by each dipole antenna is applied through level adjusting means, e.g. variable attenuator 206, 208 to a combiner 210, where the two signals are combined with each other. The amounts of attenuation given by the variable attenuators 206 and 208 are externally remote-controlled to thereby change the combined directivity direction of the two dipole antennas 202 and 204 stepwise by a predetermined angle of, for example, 22.5 degrees, along a circumference of a circle centered about the intersection of the dipole antennas 202 and 204, as shown in FIG. 3. With this arrangement, the combined directivity can be changed to any one of different sixteen (16), for example, directions a through p. The variable directivity antenna 2 is a wide band antenna capable of receiving all UHF-band terrestrial digital broadcast signals.

The variable directivity antenna 2 includes therein amplifying means, e.g. high frequency amplifiers 212 and 214. Bypass switches 216 and 218 are externally remote-controlled to cause the UHF-band high frequency signals received by the dipole antennas 202 and 204 to be applied through the high frequency amplifiers 212 and 214, respectively, or directly, to the variable attenuators 206 and 208.

The UHF-band high frequency signals from the variable directivity antenna 2 are applied through a control box 4 to a set-top box 6. The control signal for varying the directivity and the control signal for applying the high frequency signals to the amplifiers 212 and 214 or bypassing them around the amplifiers 212 and 214 are generated in the set-top box 6 and supplied through the control box 4 to the variable directivity antenna 2. The variable directivity antenna 2 and the control box 4 are connected by one coaxial cable in practice, through which the high frequency signal and the control signals are transferred. Power for operating the high frequency amplifiers 212 and 214 in the variable directivity antenna 2 is supplied from the set-top box 6 to the control box 4, from which power is supplied through the coaxial cable to the variable directivity antenna 2. In order to make it possible to provide power and control signals to the variable directivity antenna 2, the control signals are modulated in the control box 4. The control box 4 is for the purpose of modulation. Therefore, when the control signals and power are arranged to be separately supplied from the set-top box 6, the control box 4 can be eliminated.

The set-top box 6 includes therein a tuner 8, to which UHF-band high frequency signals from the control box 4 are applied. The tuner 8 includes tuning means, e.g. a tuned circuit, for selecting a terrestrial digital broadcast signal of a desired frequency band or channel, from the UHF-band high frequency signals. The tuned circuit is arranged such that the terrestrial digital broadcast channel to be selected by the tuned circuit can be changed. The tuner 8 converts the terrestrial digital broadcast signal of the selected channel to an intermediate frequency signal and then demodulates it to a baseband signal, before supplying it to a television receiver. The tuner 8 is also provided with level detecting means for detecting a signal level of a terrestrial digital broadcast signal of a selected channel, or its intermediate frequency version, or a baseband signal resulting from transforming the intermediate frequency signal. The level detecting means may be, for example, a level detecting circuit 9 for detecting a peak level within a predetermined time period. A detected-level representative signal from the level detecting circuit 9 is applied to a control unit 10.

The control unit 10 includes control means, e.g. a CPU 12, and memory means, e.g. a ROM 14 and a RAM 16. Programs for operating the CPU 12 and data required for the CPU 12 to operate are stored in the ROM 14. The RAM 16 operates as a work area for the operation of the CPU 12. The CPU 12 receives a channel selection signal from operating means, e.g. a remote control transmitter (not shown). The CPU 12 operates, in accordance with instructions given on the channel selection signal, to switch the channel to be selected in the tuner 8 and, also, to supply required control signals to the control box 4 through an interface 18 in order to direct the directivity of the variable directivity antenna 2 to the direction in which the terrestrial digital broadcast signal of the selected channel can be received. A power supply unit 20 supplies power necessary for operating the control unit 10, the tuner 8, and the high frequency amplifiers in the variable directivity antenna 2.

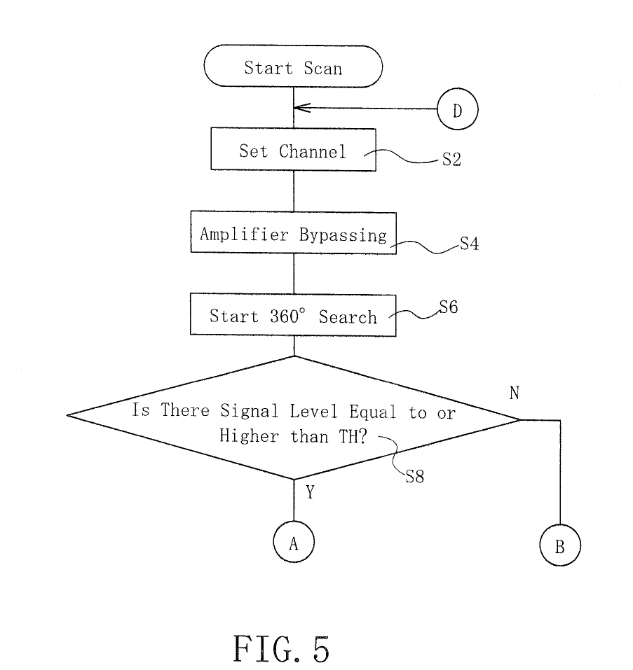

As described above, in the described signal receiving system, when the channel selection signal representative of the terrestrial digital broadcast signal of desired channel is sent from the remote control transmitter, the directivity of the variable directivity antenna 2 needs to be directed to the direction from which the desired terrestrial digital broadcast signal wave comes. For that purpose, when the signal receiving system is installed on the desired site, the control unit 10 executes processing shown in FIGS. 5-9, FIGS. 5, 9 and 10-12, or FIGS. 5, 9 and 13-15, for determining the true signal wave coming direction (hereinafter also referred to as signal receiving direction) from which the true signal wave comes.

In the processing shown in FIG. 5, the control unit 10 first sets the tuner 8 to receive a signal of one of terrestrial digital broadcast channels to be received (Step S2). Next, the control unit 10 causes an amplifier-bypassing step to be taken (Step S4). In this amplifier-bypassing step, the variable directivity antenna 2 is supplied with such a control signal as to make the high frequency signals as received by the dipole antennas 202 and 204 bypass the high frequency amplifiers 212 and 214, respectively, so that they are not amplified in the amplifiers. Then, the direction of the directivity of the variable directivity antenna 2 is changed, starting from the reference direction a, successively by an angle of 22.5 degrees, and the detected-level representative signals developed by the tuner 8 for the respective directions are supplied to the control unit 10 where they are stored together with the associated directions (Step S6). Then, a judgment is made as to whether there is a detected-level representative signal equal to or higher than a threshold TH, which is the level required for a terrestrial digital broadcast signal to be satisfactorily received (Step S8). In other words, a judgment is made as to whether the terrestrial digital broadcast signal of the selected channel is being received satisfactorily without resort to the amplification in the high frequency amplifiers 212 and 214. The threshold level TH is preset.

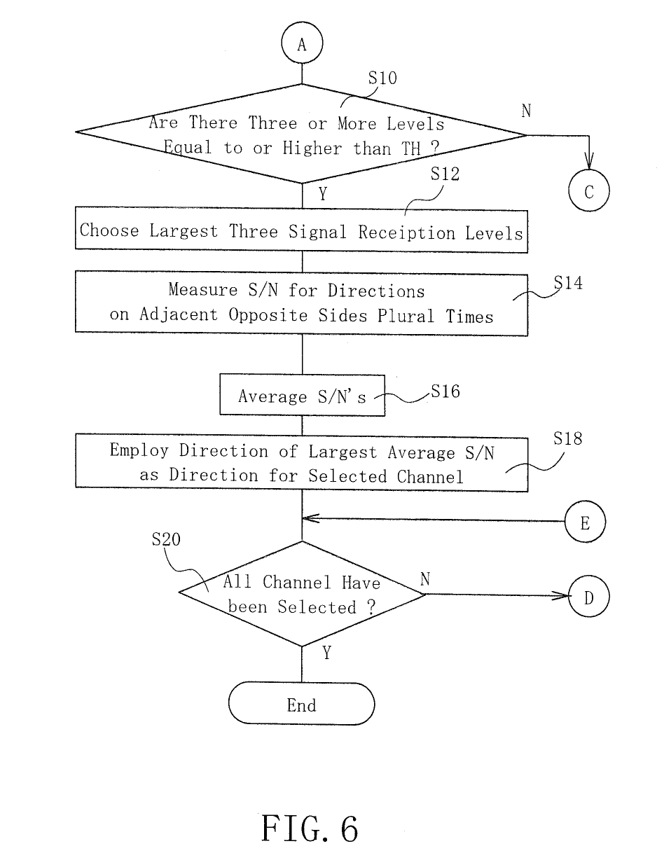

If the answer to the query in Step S8 is YES, a judgment as to whether there are three or more reception levels equal to or above the threshold TH is made (Step S10), as shown in FIG. 6. This judgment is for determining whether the terrestrial digital broadcast signal of the selected channel is being received in three or more directions, other than the true signal receiving direction, due to influences of multiple signal paths etc. If the selected channel signal is being received from three or more directions, the largest three reception levels among them equal to or higher than the threshold TH are selected (Step S12). Let it be assumed that the received signal levels in three directions b, g and l (FIG. 3) are selected in Step S12. (Hereinafter, such selected directivity directions are referred to as searched directivity directions.)

A signal-to-noise ratio (S/N) is measured plural times in each of the directions on opposite adjacent sides of each of the searched directivity directions (Step S14). As for the searched directivity direction b shown in FIG. 4a, for example, the S/N ratio is measured plural times for each of the adjacent directions a and c. For the searched directivity direction g shown in FIG. 4b, the S/N is measured plural times for each of the adjacent directions f and h. For the searched directivity direction l shown in FIG. 4c, the S/N is measured plural times for each of the adjacent directions k and m. To this end, the control unit 10 directs the directivity direction of the variable directivity antenna 2 to the direction a and measures the S/N plural times, and then, directs the directivity direction of the antenna 2 to the direction c and measures the S/N plural times, for the searched directivity direction b. The control unit 10 operates in the same manner for other searched directivity directions. A technique for measuring the S/N is known, and, therefore no detailed description about it is given.

The thus obtained S/N's determined for each searched directivity direction are averaged (Step S16). For example, the S/N′ on one and the other sides of each of the searched directivity directions are averaged, and, then, the two averages for each searched directivity direction are further averaged. For the searched directivity direction b, for example, the plural S/N's in the direction a are averaged, the plural S/N's in the direction c are averaged, and the thus determined two averages are further averaged.

The average S/N values for the respective searched directivity directions determined in the above-described manner are compared with each other, and the searched directivity direction exhibiting the best or highest S/N is employed as the direction for the selected channel and stored, being correlated with the selected channel (Step S18). In general, when the directivity direction of a variable directivity antenna is oriented to the direction from which a desired signal wave comes, the signal wave is also received at some level in the directions on adjacent opposite sides of the desired signal wave coming direction, and, therefore the S/N's of the signal from these adjacent directions are high. On the other hand, if the antenna directivity direction is oriented to the direction different from the direction from which the true, desired signal wave comes, due to influences of multiple paths etc., the levels of the desired signal wave received in the adjacent directions are lower, resulting in lower S/N ratios. Thus, the direction intermediate between adjacent directions exhibiting high S/N ratios can be judged to be the direction from which the desired signal wave comes. For the searched directivity directions b, g and l, for example, the searched directivity direction b is the most acceptable direction since the signal reception levels in its adjacent directions a and c, too, partly exceed the threshold TH, as is seen from FIGS. 4a, 4b and 4c. Then, this searched directivity direction b is employed as the desired signal wave coming direction, from which the desired wave comes.

As described above, the average of the S/N ratios is calculated for each of directions on opposite, adjacent sides of each of all of the searched directivity directions exhibiting the signal reception level equal to or higher than the threshold level TH, and the direction exhibiting the most acceptable or largest S/N ratio is employed as the antenna directivity direction for the selected channel. However, this manner may need a long time necessary to determine the direction from which the desired signal wave comes. Therefore, according to the described embodiment, the searched directivity directions are limited to three directions in which the highest three reception signal levels are obtained. It should be noted, however, that the number of the searched directivity directions need not be three, but it can be two or more, but less than the total number of directions for which the signal reception level is measured. The number of the searched directivity directions to be used can be determined, taking into account the time useable for determining the true direction from which the desired signal wave comes.

After determining the direction for one channel, a judgment is made as to whether the directions for all of desired channels have been determined (Step S20). If the answer to this question is YES, the processing is finished. If the answer is NO, a new channel is selected in Step S2 shown in FIG. 5, and the above-described operation is iterated.

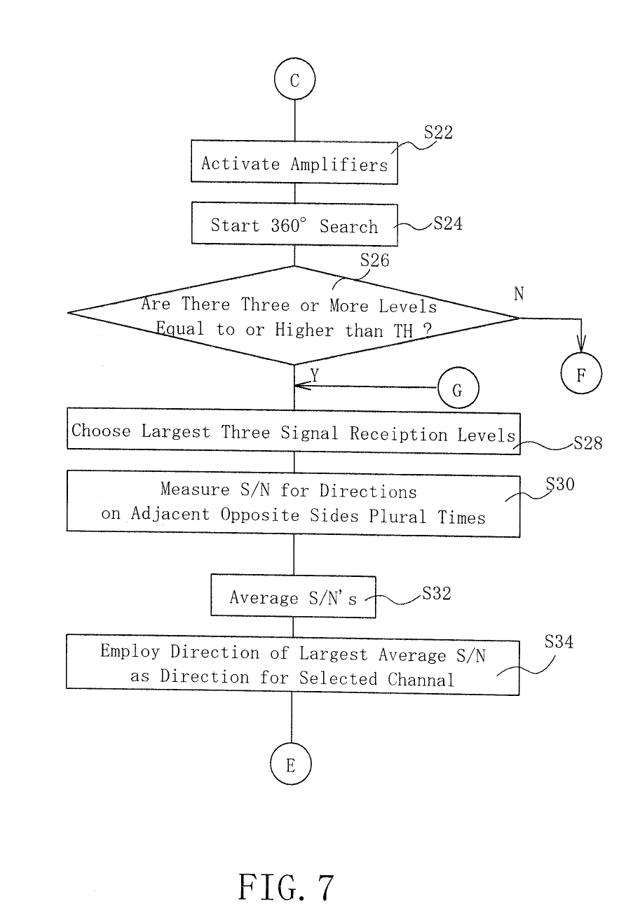

If a judgment that there are less than three signal levels equal to or higher than the threshold TH, is made in Step S10, an amplifier activating operation is initiated so that the received high frequency signal can be amplified in the high frequency amplifiers 214 and 216 (Step S22), as shown in FIG. 7. This operation is for increasing the possibility of increasing the number of the signal receiving levels equal to or above the threshold TH to three or more. Thereafter, as in Step S6, the signal reception levels for the respective directions are stored, being correlated with the associated directions (Step S24), and, as in Step 10, a judgment is made as to whether there are three or more signal reception levels equal to or higher than the threshold TH (Step S26). If it is judged that there are three or more signal reception levels equal to or above TH, processing as executed in Steps S12, S14, S16 and S18 is executed in Steps S28, S30, S32 and S34, to thereby determine the direction for the selected channel, followed by the processing of Step S20. Then, the determination of the direction for a next channel is executed.

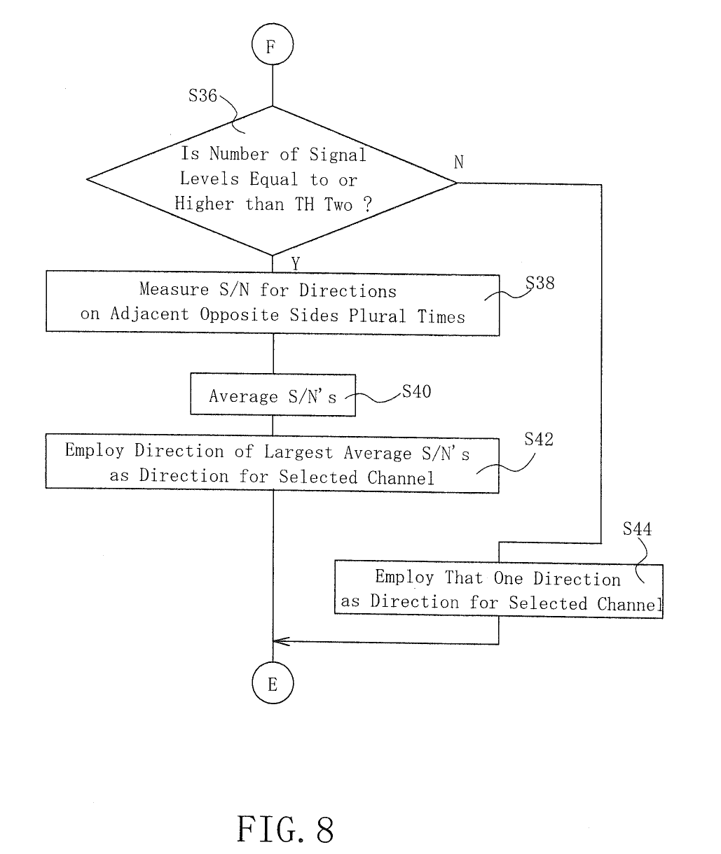

If it is judged, in Step S26, that the number of signal receiving levels equal to or higher than the threshold TH is less than three, a judgment is made as to whether the number of signal receiving levels equal to or higher than the threshold TH is two (Step S36) as shown in FIG. 8. If the answer to this question is YES, the processing as executed in Steps S14, S16 and S18 is executed, in Steps S38, S40 and S42, for the signal reception levels for the directions on opposite sides of each of the two searched directivity directions, whereby the direction for the selected channel is determined. Then, Step S20 is executed, and the determination of the direction for a next channel is executed.

If it is judged, in Step S36, that the number of signal receiving levels equal to or higher than the threshold TH is not two, meaning that there is only one signal receiving level which is equal to or higher than TH, the direction exhibiting that signal reception level is employed as the direction for the selected channel (Step S44), and Step S20 is executed. After that, the determination of the direction for a next channel is executed.

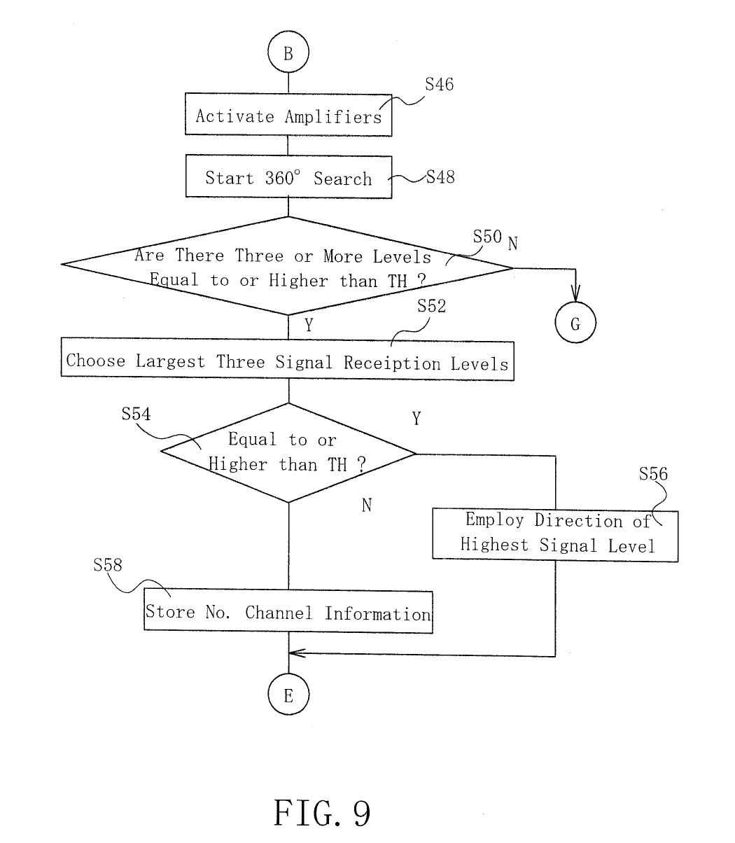

If it is judged, in Step S8, that no signal reception level equal to or higher than the threshold TH is present, the amplifier activating operation is initiated (Step S46), as done in Step S22, as shown in FIG. 9, and the signal reception levels for the respective directions are stored together with the associated directions (Step S48), as done in Step S6. Thereafter, a judgment is made, as done in Step S10, as to whether there are three or more signal reception levels equal to or higher than the threshold TH (Step S50). If the answer to this question is YES, the processing as executed in Step S28 and the succeeding steps is executed, as indicated by a circled G.

If it is judged, in Step S50, that there are less than three signal reception levels equal to or higher than the threshold TH, the highest three ones of the signal reception levels are selected (Step S52). In other words, as done in Step S6, the directivity direction of the variable directivity antenna 2 is successively changed, and the signal reception level for each direction is measured. This procedure is taken plural times, and the signal reception levels measured for each direction are averaged. Then, the largest three averages are selected. Then, a judgment is made as to whether there are signal reception levels, in the selected three signal reception levels, equal to or higher than the threshold TH (Step S54). The judgment in Step S54 is executed, since there is a possibility that a signal reception level equal to or higher than the threshold TH may result after the execution of Step S52. If the answer to the question made in Step S54 is YES, the direction in which the highest one of the signal reception levels equal to or higher than TH results is employed as the direction for that channel (Step S56). On the other hand, if the answer to the question made in Step S54 is NO, meaning that no signal wave can be received, no direction for the selected channel is stored (Step S58). Then, Step S20 is executed, and the determination of the direction for the next channel is initiated.

The present invention has been described, being embodied in a terrestrial digital broadcast signal receiving system, but the invention is not limited to such system. The invention can be embodied in satellite broadcast signal receiving system or satellite communication receiving systems, for example. In the described embodiment, Step S46 and subsequent steps are executed when the answer to the query in Step S8 is NO, but, in such case, it may be arranged such that no direction for the selected channel can be stored, as in Step S58. Also, when the answer to the query made in Step S10 is NO, Step S26 and subsequent steps may be executed, keeping the high frequency amplifiers 212 and 214 bypassed.

A carrier-to-noise ratio (C/N) or a bit error rate may be used, instead of a signal-to-noise ratio (S/N) used in the described embodiment.

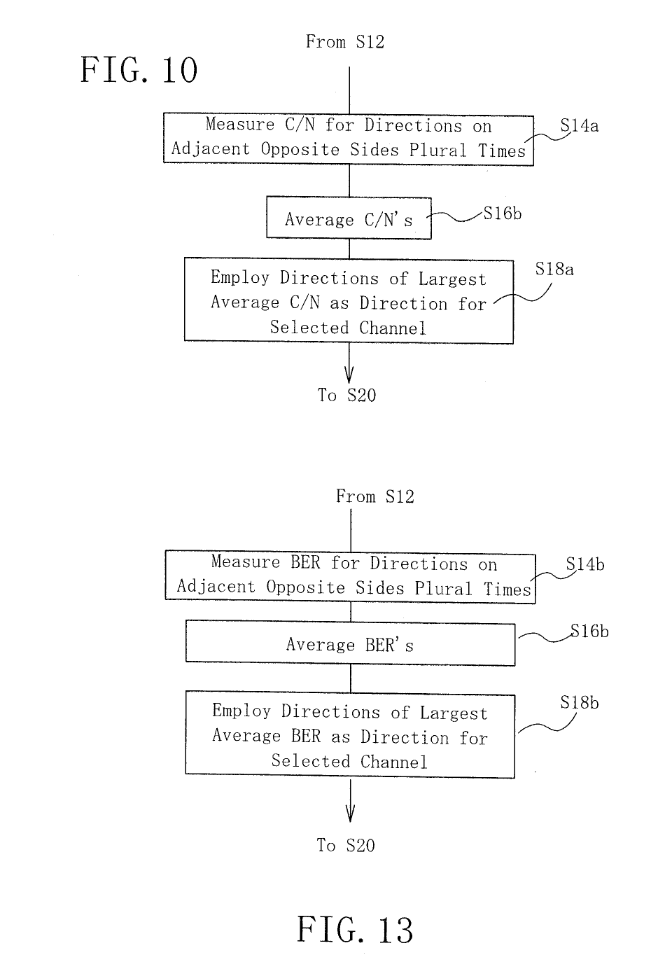

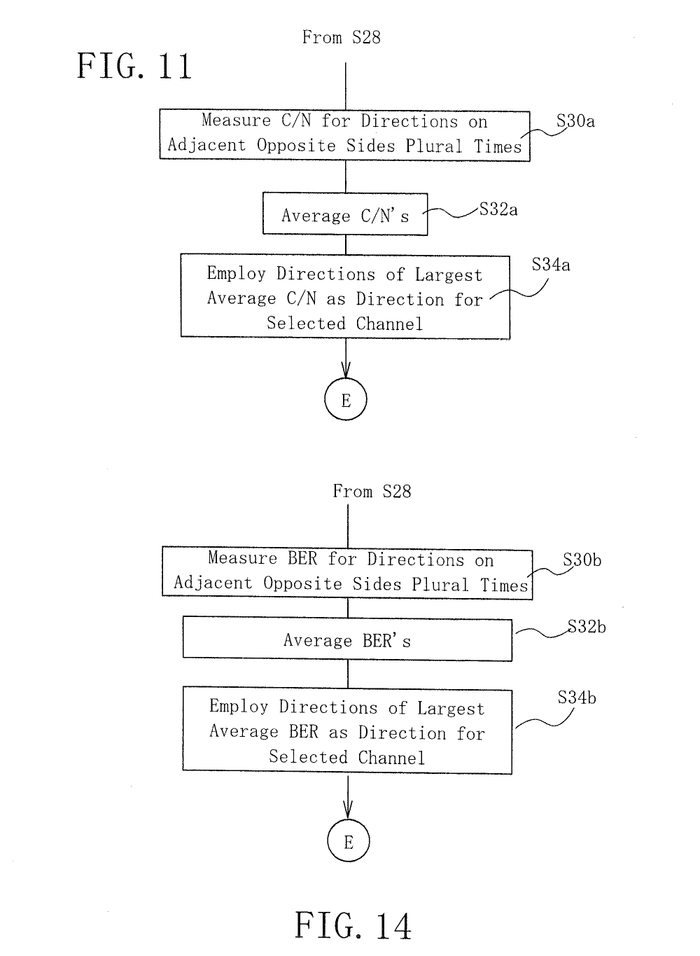

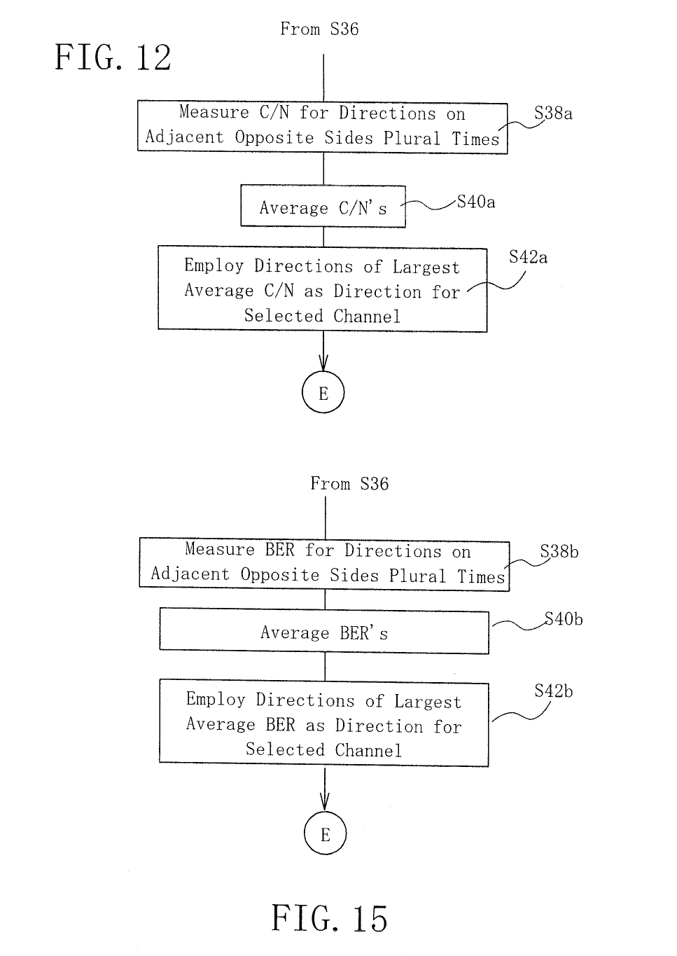

When the carrier-to-noise ratio is used, Step S14a instead of Step S14 is executed to measure a C/N ratio plural times for directions on adjacent, opposite sides of each searched directivity direction, as shown in FIG. 10, and then, Step 16a instead of Step 16 is executed to average the thus obtained plural C/N's. After that, instead of Step S18, Step S18a is executed to employ the searched directivity direction in which the highest average C/N is exhibited. In this case, as shown in FIG. 11, instead of Step S30, Step S30a is executed to measure a C/N ratio plural times for directions on adjacent opposite sides of each of the three directions exhibiting the highest three signal reception levels, and, instead of Step S32, Step S32a is executed to average the thus obtained plural C/N's. Then, instead of Step S34, Step S34a is executed to employ the searched directivity direction exhibiting the largest average C/N. Further, as shown in FIG. 12, instead of Step S38, Step S38a is executed to measure a C/N plural times for directions adjacent to the selected two directions, and, instead of Step S40, Step S40a is executed to average the thus obtained plural C/N ratios, and Step S42a is executed, instead of Step 42, to determine the searched directivity directions for the largest average C/N to be the direction for the selected channel.

When the bit error rate is used, Step 14b, instead of Step 14, is executed to measure a bit error rate plural times for directions on opposite sides of each searched directivity direction, as shown in FIG. 13, then, Step S16b, instead of Step S16, is executed to average the plural bit error rates, and, then, Step S18b, instead of Step S18, is executed to employ the searched directivity direction of the lowest average bit error rate as the direction for the selected channel. In this case, as shown in FIG. 14, Step S30b, instead of Step S30, is executed to measure a bit error rate plural times for directions on opposite sides of each of the three directions exhibiting the highest three signal reception levels, and Step S32b, instead of Step S32, is executed to average the plural bit error rates. In Step S34b, instead of Step S34, the searched directivity direction of the lowest average bit error rate is employed as the direction for the selected channel. Further, as shown in FIG. 15, Step S38b is executed instead of Step S38 to measure a bit error rate plural times for directions on opposite sides of each of the selected two signal receiving directions, and Step S40b, instead of Step S40, is executed to average the plural bit error rates. In Step S42b, instead of Step S42, the searched directivity direction of the lowest average bit error rate is employed as the direction for the selected channel.

In the described embodiments, the S/N ratio, the C/N ratio or the bit error rate is measured on both sides of each of three searched directivity directions from which a desired signal wave is received at levels equal to or higher than the threshold TH. However, the measurement may be made on at least one of the two sides of each searched directivity direction.

What is claimed is:

1. A signal receiving system comprising:
a variable directivity antenna having a direction of directivity variable stepwise along a circumference of a circle about it;
signal receiving means for selectively receiving a desired one of high frequency signals received by said variable directivity antenna;
level detecting means for detecting a level of a signal received by said signal receiving means;
searching means for searching those ones of levels of said received signal received by said signal receiving means in plural states of said variable directivity antenna with different directions of directivity thereof, which are equal to or higher than a threshold level;
detecting means for detecting a signal-to-noise ratio, a carrier-to-noise ratio or a bit error rate of said received signal received from a direction adjacent to a searched directivity direction, which is the directivity direction corresponding to said searched signal level of said received signal; and
determining means for employing said searched directivity direction corresponding to the highest signal-to-noise ratio, the highest carrier-to-noise ratio, or the lowest bit error rate, as the signal receiving direction for said variable directivity antenna.

2. The signal receiving system according to claim 1, wherein said detecting means detects a signal-to-noise ratio, a carrier-to-noise ratio or a bit error rate of said received signal received from directions on adjacent, opposite sides of said searched directivity direction.

3. The signal receiving system according to claim 1, wherein, when there are signal levels equal to or higher than said threshold level equal to or more than a predetermined number, said detecting means detects a signal-to-noise ratio, a carrier-to-noise ratio or a bit error rate of said received signal received from directions adjacent to respective ones of searched directivity directions corresponding to a predetermined number of received signals having a level equal to or higher than said threshold level selected in the order of magnitude of signal level, the highest one first.

4. The signal receiving system according to claim 1, wherein said signal receiving means or said variable directivity antenna includes amplifying means operable when no signal level is equal to or higher than said threshold level.

5. The signal receiving system according to claim 1, wherein said signal receiving means or said variable directivity antenna includes amplifying means operable when there are less than a predetermined number of signal levels equal to or higher than said threshold level.
